(19) United States
(12) Patent Application Publication
(10) Pub. No.: US 2026/0094742 A1
(43) Pub. Date: Apr. 2, 2026

(54) ELECTRONIC COMPONENT UNIT

(71) Applicant: Yazaki Corporation, Tokyo (JP)

(72) Inventors: Keisuke Yamauchi, Shizuoka (JP); Taisuke Fukatsu, Shizuoka (JP); Kotaro Akino, Shizuoka (JP)

(73) Assignee: Yazaki Corporation, Tokyo (JP)

(21) Appl. No.: 19/340,100

(22) Filed: Sep. 25, 2025

(30) Foreign Application Priority Data
Sep. 27, 2024 (JP) 2024-168705

(51) Int. Cl. H01C 1/032; H01C 1/144; H01C 7/00

(52) U.S. Cl. CPC H01C 1/032; H01C 1/144; H01C 7/008

(57) ABSTRACT

An electronic component unit includes a base member including an electronic component, an accommodation body for accommodating the electronic component by embedding the electronic component therein, and a pair of terminals connected to the electronic component and exposed to an outside of the accommodation body, a housing assembled to the base member and having a pair of accommodation chambers for accommodating the pair of terminals in a manner separated from each other, and a pair of electric wires connected to respective one of the pair of terminals inside respective one of the pair of accommodation chambers and inserted inside and outside respective one of the pair of accommodation chambers while being held by the housing.

### CROSS-REFERENCE TO RELATED APPLICATIONS

This application is based on and claims priority under 35 USC 119 from Japanese Patent Application No. 2024-168705 filed on Sep. 27, 2024, the contents of which are incorporated herein by reference.

### TECHNICAL FIELD

The present invention relates to an electronic component unit including a base member that incorporates an electronic component, a housing that has a pair of accommodation chambers for accommodating a pair of terminals exposed to the outside of the base member in a manner separated from each other, and a pair of electric wires that is connected to respective one of the pair of terminals and that is inserted inside and outside respective one of the pair of accommodation chambers.

### BACKGROUND ART

In the related art, an electronic component unit that incorporates an electronic component, for example, a temperature sensor that incorporates a temperature measuring element such as a thermistor, has been proposed. For example, in one of the electronic component units in the related art, all of a thermistor, a terminal wire extending from the thermistor, and a contact point between the terminal wire and an external electric wire are embedded in a sealing material made of a resin to fix positions of the components, to waterproof the components, and to insulate the contact points from each other (see, for example, Patent Literature 1).

### CITATION LIST

### Patent Literature

Patent Literature 1: JP2000-105151A

### SUMMARY OF INVENTION

### Technical Problem

In an electronic component unit used in an environment in which a possibility of being exposed to water is sufficiently low, there is no need for a waterproof treatment to an extent that each component or contact point is embedded in a sealing body as in the above electronic component unit in the related art. However, even in such an electronic component unit, it is generally required to fix each component and insulate the contact points from each other. In view of such a background, there is a demand for an electronic component unit that achieves fixing of each component and insulation between contact points while reducing a production cost without using a sealing body.

An object of the present invention is to provide an electronic component unit having an excellent production cost and capable of fixing each component and insulating contact points from each other.

### Solution to Problem

In order to achieve the above object, an electronic component unit according to the present invention is characterized as follows.

An electronic component unit includes a base member including an electronic component, an accommodation body for accommodating the electronic component by embedding the electronic component therein, and a pair of terminals connected to the electronic component and exposed to an outside of the accommodation body; a housing assembled to the base member and having a pair of accommodation chambers for accommodating the pair of terminals in a manner separated from each other; and a pair of electric wires connected to respective one of the pair of terminals inside respective one of the pair of accommodation chambers and inserted inside and outside respective one of the pair of accommodation chambers while being held by the housing.

### Advantageous Effects of Invention

With the electronic component unit according to the present invention, respective one of the pair of terminals connected to the electronic component embedded in the accommodation body of the base member and exposed from the accommodation body is accommodated in respective one of the pair of accommodation chambers of the housing. The pair of accommodation chambers accommodates the pair of terminals in a manner separated from each other. Further, the pair of electric wires is connected to the pair of terminals and inserted inside and outside the pair of accommodation chambers while being held by the housing. Accordingly, the electronic component and the terminal are fixed to the accommodation body, the electric wires are held by the housing, and respective one of contact points between the terminals and the electric wires is separately accommodated in respective one of the accommodation chambers without using a sealing material as in the electronic component unit in the related art. Further, since the electronic component unit can be formed by assembling the base member, the housing, and the electric wires as compared with the case of using the sealing material, an injection device or the like for the sealing material is not required in a production facility. Therefore, the electronic component unit according to the present invention has an excellent production cost, and can fix each component and insulate the contact points from each other. The present invention has been briefly described above. Further, details of the present

invention will be clarified by reading modes for carrying out the invention described below with reference to the accompanying drawings.

### BRIEF DESCRIPTION OF DRAWINGS

FIG. 1 is a perspective view showing an electronic component unit according to an embodiment of the present invention.

FIG. 2 is an exploded perspective view of the electronic component unit shown in FIG. 1.

FIG. 3 is a side view of a base member shown in FIG. 2.

FIG. 4 is a cross-sectional view taken along a line A-A in FIG. 3.

FIG. 5 is a side view showing a state where a case is assembled to the base member and lead wires are held by the case.

FIG. 6 is a top view of the base member, the case, and the lead wires shown in FIG. 5.

FIG. 7 is a perspective view of the cover shown in FIG. 2 when viewed from below.

FIG. 8 is a side view of the electronic component unit shown in FIG. 1.

FIG. 9 is an enlarged view of a portion B in FIG. 8.

FIG. 10 is a cross-sectional view taken along a line C-C in FIG. 8.

FIG. 11 is an enlarged view of a portion E in FIG. 10.

FIG. 12 is a cross-sectional view taken along a line D-D in FIG. 8.

FIG. 13 is a cross-sectional view taken along a line F-F in FIG. 12.

FIG. 14 is a perspective view showing an electronic component unit according to a modification.

### DESCRIPTION OF EMBODIMENTS

### Embodiments

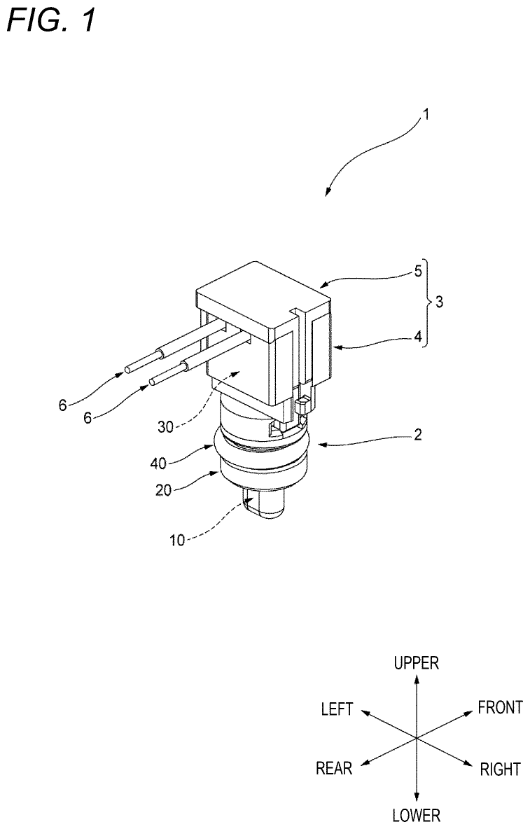

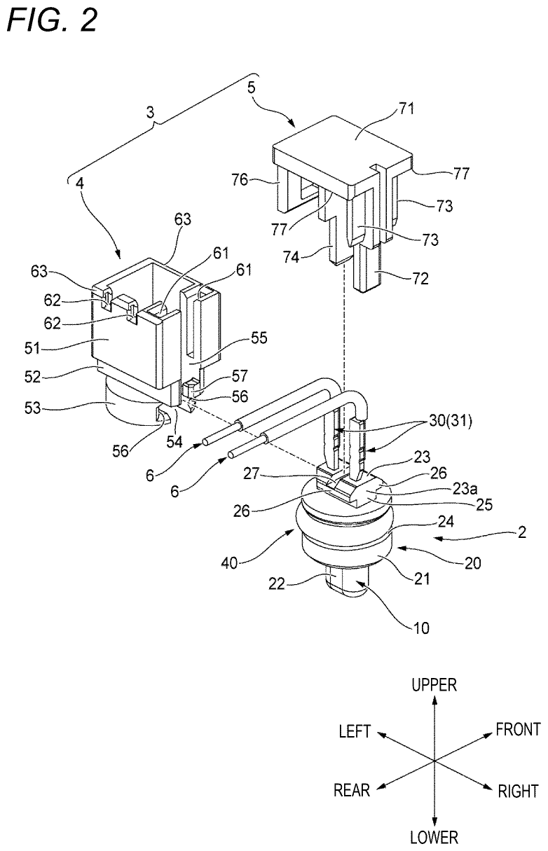

Hereinafter, an electronic component unit 1 according to an embodiment of the present invention will be described with reference to the drawings. The electronic component unit 1 shown in FIG. 1 is used as a temperature sensor, for example, in a state where a base member 2 to be described later is inserted into and fixed to an attachment hole (not shown) in an attachment target. The attachment target is, for example, a wall of a container in which transmission oil, engine oil, or the like for a vehicle is stored, and in this case, the electronic component unit 1 attached to the attachment target functions to measure the temperature of the oil in the container. As shown in FIG. 2, the electronic component unit 1 includes the base member 2, a case 4 to be assembled to the base member 2, and a cover 5 to be assembled to the case 4. The case 4 and the cover 5 constitute a housing 3.

Hereinafter, for convenience of description, “front”, “rear”, “left”, “right”, “up”, and “down” are defined as shown in FIG. 1. A “front-rear direction”, a “left-right direction”, and an “up-down direction” are orthogonal to one another. The up-down direction corresponds to a “cylinder axis direction” in the present invention. The front-rear direction, the left-right direction, and the up-down direction do not necessarily match the front-rear direction, the left-right direction, and the up-down direction of a vehicle or the like on which the electronic component unit 1 is to be mounted. Hereinafter, components constituting the electronic component unit 1 will be described in order.

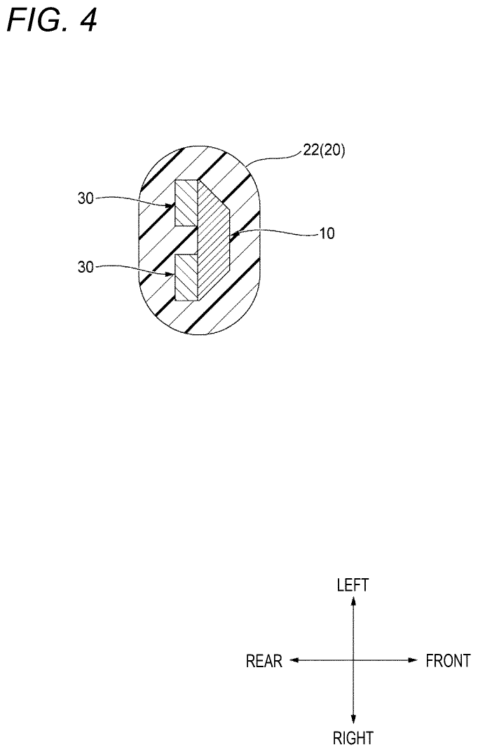

First, the base member 2 will be described. As shown in FIGS. 2 to 4, 10, and the like, the base member 2 includes an electronic component 10 (see FIG. 4), an accommodation body 20 for accommodating the electronic component 10 by embedding the electronic component 10 therein, and a pair of terminals 30 connected to the electronic component 10 and exposed to the outside of the accommodation body 20. Specifically, the electronic component 10 is a thermistor element. The electronic component 10 and the pair of terminals 30 are integrated with the accommodation body 20 made of a resin by transfer molding or the like so as to be stored (embedded) inside the accommodation body 20.

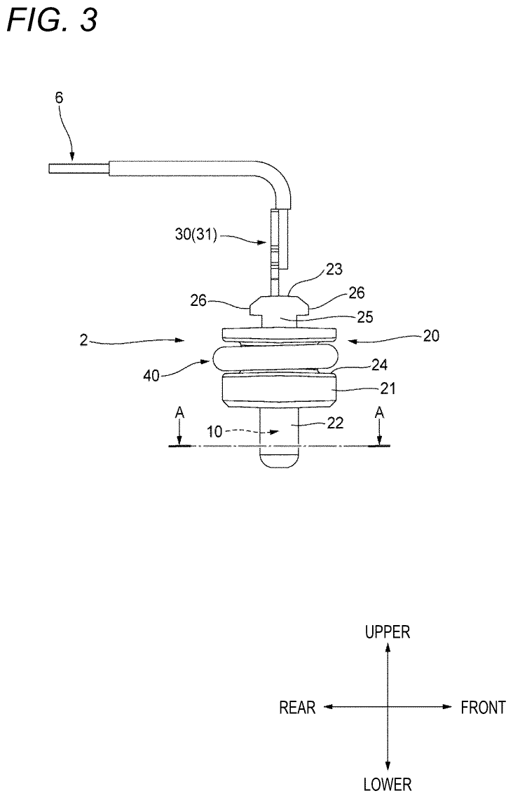

As shown in FIGS. 2, 3, and the like, the accommodation body 20, which is a resin molded body, integrally includes a columnar body portion 21 extending in the up-down direction, a protruding portion 22 protruding downward from a lower face of the body portion 21, and a projection portion 23 projecting upward from an upper face of the body portion 21. An annular groove 24 is formed in an outer peripheral face of the body portion 21, and a rubber O-ring 40 is mounted in the annular groove 24. The O-ring 40 mounted in the annular groove 24 is brought into close contact with an inner peripheral wall of the attachment hole of the attachment target to exhibit a sealing function. As can be understood from FIG. 4, the protruding portion 22 has an elongated hole shape elongated in the left-right direction and protrudes downward from the body portion 21, and the entire electronic component 10 is embedded in the protruding portion 22. As shown in FIGS. 2, 3, and the like, the projection portion 23 includes a first portion 25 projecting upward from the upper face of the body portion 21 and extending in the left-right direction, and a pair of second portions 26 projecting from the entire region in the left-right direction on an upper end portion of the first portion 25 toward both sides in the front-rear direction, and has a substantially T shape when viewed in the left-right direction. A groove portion 27 penetrating the front-rear direction is formed in a central portion of an upper face of the projection portion 23 in the left-right direction.

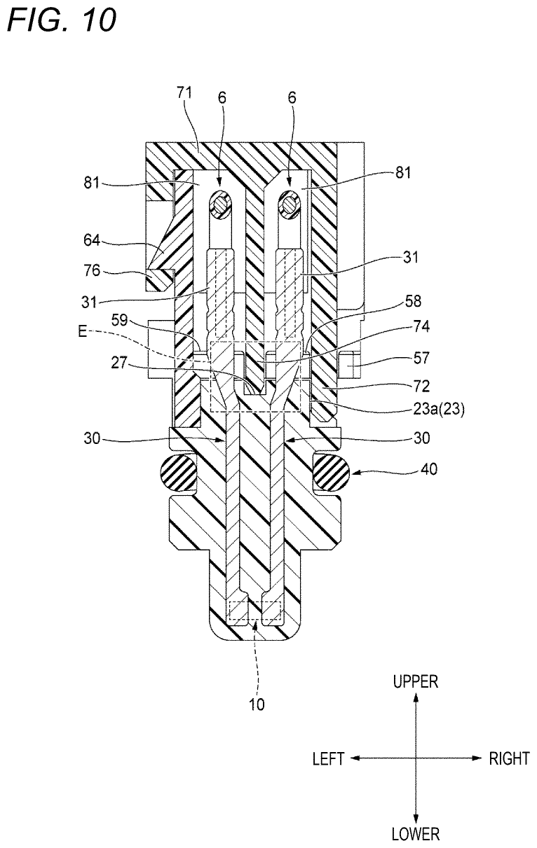

As can be understood from FIGS. 4, 10, and the like, the pair of terminals 30 each have a shape extending substantially linearly in the up-down direction and are arranged side by side at an interval in the left-right direction, and the entire portion extending in the up-down direction and located below an exposed portion 31, that is an upper region, is embedded over the projection portion 23, the body portion 21, and the protruding portion 22 of the accommodation body 20. Lower end portions of the pair of terminals 30 located in the protruding portion 22 are connected to the electronic component 10 (see FIG. 4). The exposed portions 31 of the pair of terminals 30 protrude upward from positions on both left and right sides of the groove portion 27 in an upper end face of the projection portion 23, and are exposed to the outside of the accommodation body 20. As shown in FIG. 2 and the like, one end portions of a pair of lead wires 6 are connected to respective one of the exposed portions 31 of the pair of terminals 30 by welding, and the lead wires 6 respectively extend upward from the exposed portions 31 of the pair of terminals 30. Each of the pair of lead wires 6 has flexibility so as to be freely bendable.

Next, the case 4 will be described. The case 4 is a component to be assembled to the base member 2. The case 4 is a resin molded body, and as shown in FIGS. 2, 5, 13, and the like, integrally includes a substantially rectangular box-shaped body portion 51 having an open upper end, an elongated portion 52 protruding downward from a central portion of a bottom wall of the body portion 51 in the front-rear direction and extending in the left-right direction, and a columnar portion 53 continuous with a lower portion of the elongated portion 52 and extending in the up-down direction. An outer diameter of the columnar portion 53 is substantially equal to an outer diameter of the body portion 21 of the accommodation body 20 (see FIGS. 1, 5, 8, and the like).

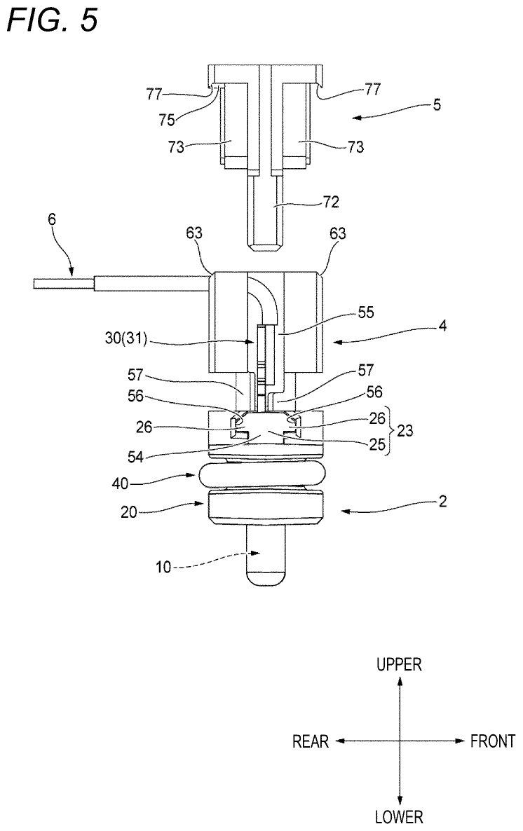

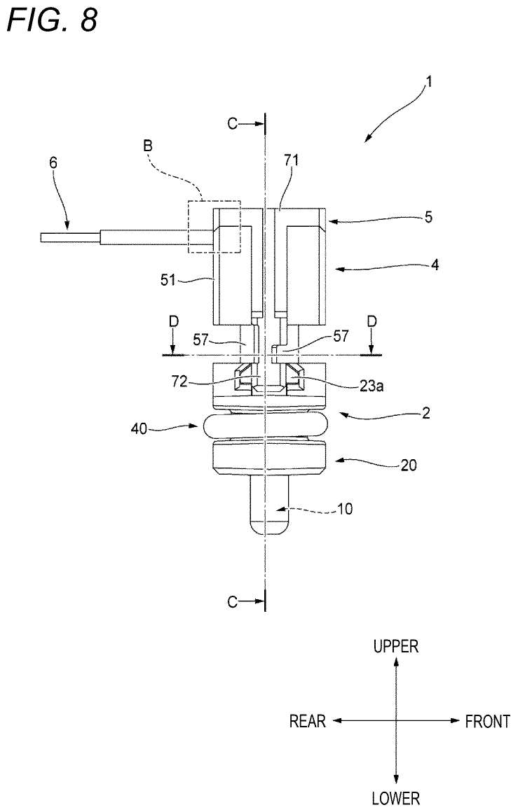

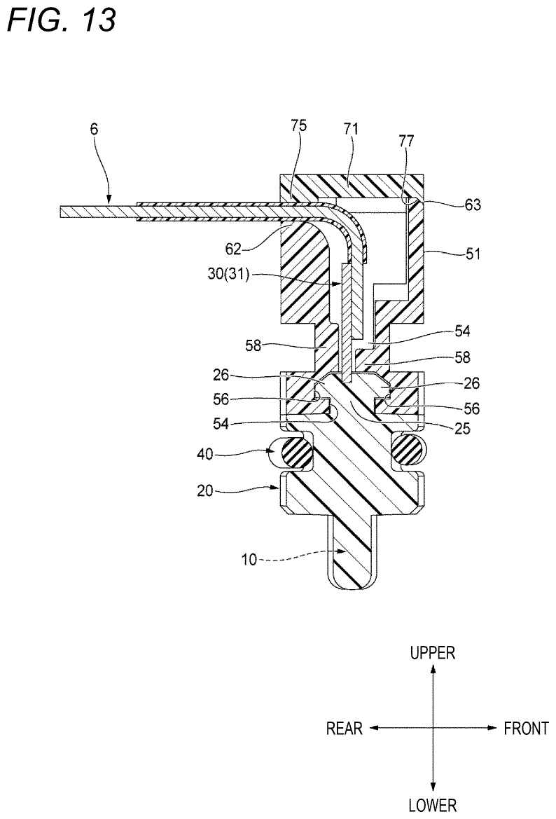

In the case 4, a slit portion 54 extending in the left-right direction from a right end to a vicinity portion of a left end of the elongated portion 52 and the columnar portion 53 is formed over the entire region in the up-down direction at a central portion of the elongated portion 52 and the columnar portion 53 in the front-rear direction (see FIGS. 2, 5, 12, and 13). The slit portion 54 opens rightward at the right end of the elongated portion 52 and the columnar portion 53, opens upward at an upper face of the elongated portion 52 (that is, a bottom face of the body portion 51), and opens downward at a lower face of the columnar portion 53. Further, in the case 4, a slit portion 55 extending in the up-down direction over the body portion 51 and the elongated portion 52 is formed at a central portion of a substantially rectangular flat plate-shaped right side wall of the body portion 51 and a right end portion of the elongated portion 52 in the front-rear direction (see FIGS. 2 and 5). The slit portion 55 opens in each of an upper face of the right side wall of the body portion 51, a lower face of the elongated portion 52, and inner and outer faces (left and right end faces) of the right side wall of the body portion 51. A lower end portion of the slit portion 55 overlaps a right end portion of the slit portion 54. Since the slit portion 54 and the slit portion 55 are formed in the case 4, the case 4 has a shape that is easily deformed to widen the slit portion 54 and the slit portion 55. When the case 4 is assembled to the base member 2, the first portion 25 of the projection portion 23 of the base member 2 and the exposed portions 31 of the pair of terminals 30 are accommodated in the slit portion 54 (see FIG. 13 and the like), and the exposed portions 31 of the pair of terminals 30 and the pair of lead wires 6 pass through the slit portion 55 (see FIG. 13 and the like). When the cover 5 is assembled to the case 4, an extending portion 72 (to be described later) of the cover 5 is accommodated in the slit portion 55 (see FIG. 8)

A pair of front and rear groove portions 56 recessed outward in the front-rear direction and extending in the left-right direction is formed in inner walls on both front and rear sides of the slit portion 54 located in the columnar portion 53 corresponding to the pair of front and rear second portions 26 of the projection portion 23 of the base member 2 (see FIGS. 2, 5, and 13). When the case 4 is assembled to the base member 2, the pair of front and rear second portions 26 of the projection portion 23 of the base member 2 is accommodated in the pair of front and rear groove portions 56.

On inner walls on both front and rear sides of the slit portion 54 located in the elongated portion 52, a pair of front and rear projection portions 57 projecting toward the inside of the slit portion 54 is provided at the right end portion of the slit portion 54 (that is, the lower end portion of the slit portion 55), a pair of front and rear projection portions 58 projecting toward the inside of the slit portion 54 is provided at a position where the exposed portion 31 of the right terminal 30 is disposed when the case 4 is assembled to the base member 2, and a pair of front and rear projection portions 59 projecting toward the inside of the slit portion 54 is provided at a position where the exposed portion 31 of the left terminal 30 is disposed when the case 4 is assembled to the base member 2 (see FIGS. 2, 5, 6, and the like).

A pair of front and rear groove portions 61 recessed outward in the front-rear direction and extending in the up-down direction from an upper end of the right side wall to an intermediate position in the up-down direction is formed in inner walls on both front and rear sides of the slit portion 55 formed in the right side wall of the body portion 51. When the cover 5 is assembled to the case 4, a pair of front and rear projection portions 73 (to be described later) of the cover 5 is accommodated in the pair of front and rear groove portions 61.

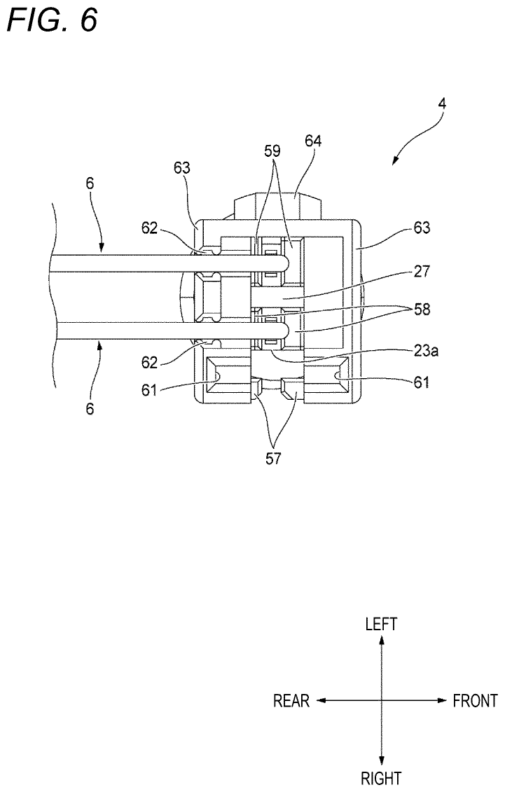

A pair of left and right recess portions 62 recessed downward is formed in an upper edge portion extending in the left-right direction at a substantially rectangular flat plate-shaped rear side wall of the body portion 51, corresponding to the pair of left and right lead wires 6 extending from the exposed portions 31 of the pair of left and right terminals 30. When the case 4 is assembled to the base member 2, the pair of left and right lead wires 6 is inserted into the pair of left and right recess portions 62 (see FIGS. 1, 6, and the like). A width (interval in the left-right direction) of each of the pair of left and right recess portions 62 is slightly smaller than the outer diameter of the lead wire 6. As a result, the lead wire 6 is press-fitted into the recess portion 62.

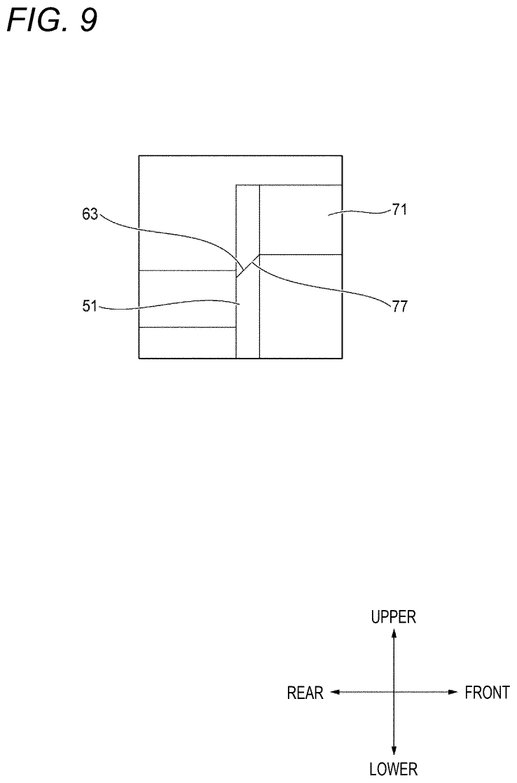

An inclined face (flat face) 63 inclined outward in the front-rear direction is formed on an upper edge portion extending in the left-right direction at each of substantially rectangular flat plate-shaped front side wall and rear side wall of the body portion 51 (see FIGS. 2, 5, and the like). When the cover 5 is assembled to the case 4, a pair of front and rear inclined faces 77 (to be described later) of the cover 5 is in face contact with the pair of front and rear inclined faces 63 (see FIGS. 5 and 9). A locking projection 64 is formed on an outer side face of a substantially rectangular flat plate-shaped left side wall of the body portion 51 (see FIGS. 6 and 10). When the cover 5 is assembled to the case 4, an edge of a locking hole of a locking frame portion 76 (to be described later) of the cover is engaged with the locking projection 64 (see FIG. 10).

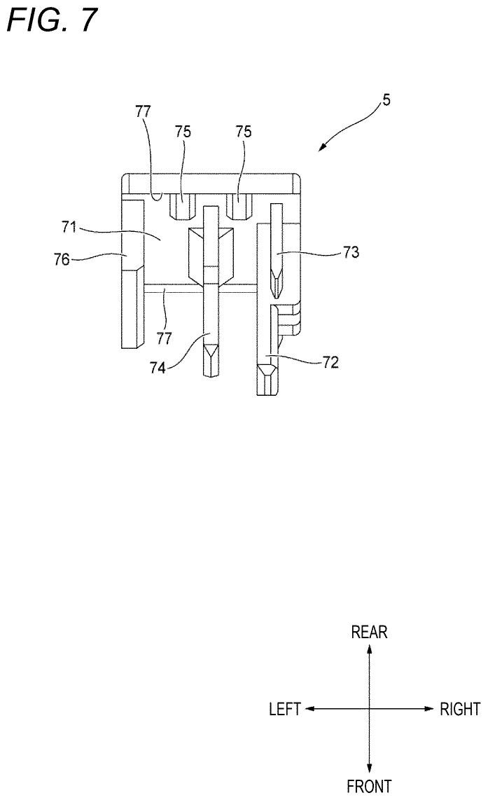

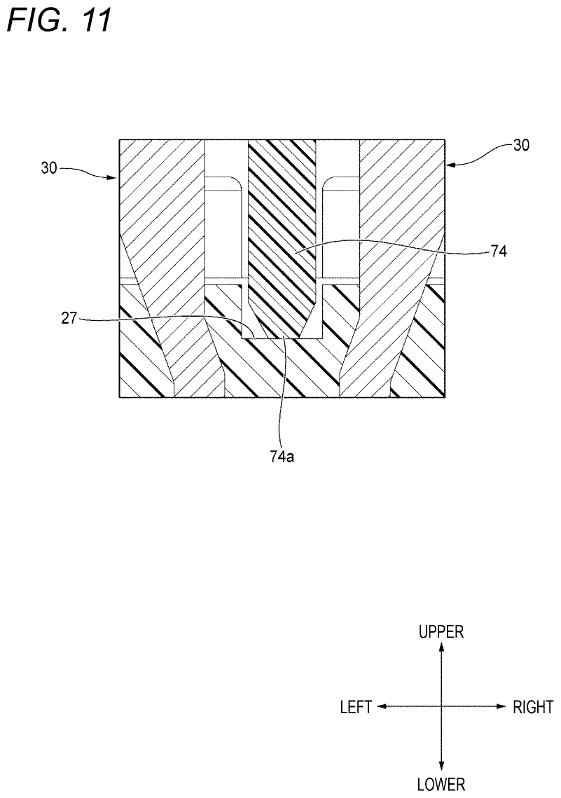

Next, the cover 5 will be described. The cover 5 is a component to be assembled to the case 4 in a state of being assembled to the base member 2. The cover 5 is a resin molded body, and as shown in FIGS. 2 and 7, includes a top plate portion 71 having a rectangular flat plate shape corresponding to the shape of the upper end opening of the case 4 (body portion 51). At a central portion in the front-rear direction in a right end edge portion of the top plate portion 71 extending in the front-rear direction, the extending portion 72 having a substantially elongated flat plate shape is provided to extend downward corresponding to the slit portion 55 of the case 4. The pair of front and rear projection portions 73 projecting outward in the front-rear direction and extending in the up-down direction is provided on front and rear side faces of the extending portion 72. An extending portion 74 having a substantially elongated flat plate shape is provided on the top plate portion 71 at a central portion in the left-right direction and a central portion in the front-rear direction so as to extend downward. When the cover 5 is assembled to the case 4, a tip (lower end) 74a of the extending portion 74 enters the groove portion 27 of the projection portion 23 of the base member 2 and comes into contact with a bottom wall of the groove portion 27 (see FIGS. 10 and 11).

A pair of left and right projection portions 75 is formed at a rear end edge portion of the top plate portion 71 extending in the left-right direction so as to project downward corresponding to the pair of left and right recess portions 62 of the case 4 (see FIGS. 7 and 13). The locking frame portion 76 having a locking hole is provided at a left end edge portion of the top plate portion 71 so as to extend downward corresponding to the locking projection 64 of the case 4. Each of a front end edge portion and a rear end edge portion of a lower face of the top plate portion 71 extending in the left-right direction is formed with the inclined face (flat face) 77 inclined inward in the front-rear direction corresponding to the pair of front and rear inclined faces 63 of the case 4 (see FIGS. 2, 5, and the like). The components constituting the electronic component unit 1 have been described above.

Next, a procedure of assembling the electronic component unit 1 will be described. In order to assemble the electronic component unit 1, first, the case 4 is assembled to the base member 2 from a left side. Specifically, from a state where the case 4 is disposed on the left side of the base member 2 (see FIG. 2), the case 4 is assembled to the base member 2 such that the exposed portions 31 of the pair of terminals 30 and the pair of lead wires 6 pass through the slit portion 55, the first portion 25 of the projection portion 23 and the exposed portions 31 of the pair of terminals 30 are accommodated in the slit portion 54, and the pair of front and rear second portions 26 of the projection portions 23 is accommodated in the pair of front and rear groove portions 56 (see FIGS. 5, 13, and the like).

In a state where the assembly of the case 4 to the base member 2 is completed, the pair of front and rear second portions 26 of the projection portion 23 of the base member 2 and the pair of front and rear groove portions 56 of the case 4 are engaged with each other, thereby preventing the case 4 from falling off upward from the base member 2. The slit portion 54 of the case 4 is closed by the first portion 25 of the projection portion 23 accommodated in the slit portion 54. The exposed portions 31 of the pair of terminals 30 of the base member 2 are surrounded by a side wall portion of the body portion 51 of the case 4 (see FIG. 13 and the like). The right exposed portion 31 is located between the pair of front and rear projection portions 58, and the left exposed portion 31 is located between the pair of front and rear projection portions 59 (see FIG. 6). The pair of lead wires 6 extending upward from the exposed portions 31 of the pair of terminals 30 is bent rearward at root portions. One portion in an extending direction of the pair of lead wires 6 extending rearward in the front-rear direction from the bent portion is press-fitted into corresponding one of the pair of recess portions 62 of the case 4 (see FIGS. 6, 13, and the like).

Next, the cover 5 is assembled to the case 4 from an upper side. Specifically, from a state where the cover 5 is disposed on the upper side of the case 4 (see FIG. 2), the cover 5 is assembled to the case 4 such that the top plate portion 71 closes the upper end opening of the body portion 51 and the extending portion 72 is accommodated in the slit portion 55 (see FIG. 8), such that both front and rear end portions of a tip portion (lower end portion) of the extending portion 72 are sandwiched in the left-right direction by the pair of front and rear projection portions 57 and the pair of front and rear projection portions 58, such that the pair of front and rear projection portions 73 is accommodated in the pair of front and rear groove portions 61, such that the extending portion 74 enters between the exposed portions 31 of the pair of left and right terminals 30 and separates the pair of left and right exposed portions 31 in the left-right direction (see FIG. 10), such that both front and rear end portions of a tip portion (lower end portion) of the extending portion 74 are sandwiched in the left-right direction by the pair of front and rear projection portions 58 and the pair of front and rear projection portions 59, such that the tip (lower end) 74a of the extending portion 74 enters the groove portion 27 of the projection portion 23 of the base member 2 and comes into contact with the bottom wall of the groove portion 27 (see FIG. 11), and such that the edge of the locking hole of the locking frame portion 76 is engaged with the locking projection 64. By assembling the cover 5 to the case 4, the assembly of the electronic component unit 1 is completed.

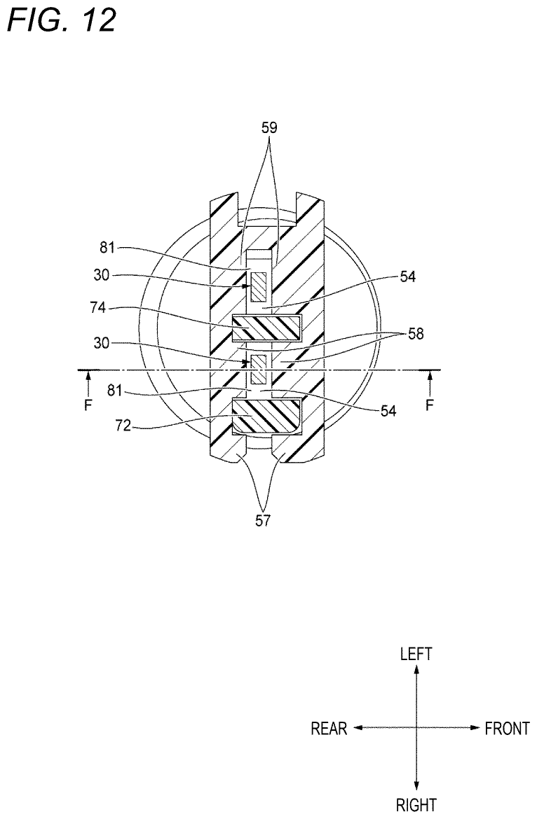

In a state where the assembly of the case 4 to the cover 5 is completed, the top plate portion 71 closes the upper end opening of the body portion 51. When the edge of the locking hole of the locking frame portion 76 is engaged with the locking projection 64 (see FIG. 10), the cover 5 is prevented from falling off upward from the case 4. The tip portion of the extending portion 72 is in contact with (engaged with) a right end face 23a (see FIGS. 2 and 6) of the projection portion 23 of the base member 2 (see FIG. 10). Further, the pair of front and rear projection portions 73 is accommodated in the pair of front and rear groove portions 61. Accordingly, the cover 5 is prevented from falling off leftward from the case 4. The slit portion 55 of the case 4 is closed by the extending portion 72 accommodated in the slit portion 55. When the pair of front and rear projection portions 57 of the case 4 overlaps the extending portion 72 (see FIGS. 8 and 12), deformation of the extending portion 72 to separate from the slit portion 55 is regulated. The extending portion 74 divides a hollow portion of the body portion 51 into two in the left-right direction, thereby defining a pair of left and right accommodation chambers 81 inside the body portion 51 (see FIGS. 10 and 12). Respective one of the exposed portions 31 of the pair of terminals 30 is accommodated in respective one of the pair of accommodation chambers 81. Accordingly, the exposed portions 31 of the pair of terminals 30 are accommodated in a manner separated from each other. The tip (lower end) 74a of the extending portion 74 is pressed against the bottom wall of the groove portion 27 of the projection portion 23 of the base member 2 and crushed (see FIG. 11). Accordingly, a degree of insulation of the exposed portions 31 of the pair of terminals 30 is further improved. Each of the pair of lead wires 6 extending from the exposed portions 31 of the pair of terminals 30 extends rearward from each of the pair of accommodation chambers 81 to the outside of the electronic component unit 1 via the recess portion 62. The pair of left and right projection portions 75 of the cover 5 presses the lead wires 6 press-fitted into the pair of left and right recess portions 62 of the case 4 from the upper side (see FIG. 13). Accordingly, even when an external force is applied to the lead wire 6 extending from the electronic component unit 1 to the outside, the external force is prevented from being applied to a contact point between the lead wire 6 and the terminal 30 (exposed portion 31). The pair of front and rear inclined faces 77 of the cover 5 is in face contact with the pair of front and rear inclined faces 63 of the case 4, respectively. Accordingly, the deformation of the case 4 to widen the slit portion 54 and the slit portion 55 due to the engagement between the inclined face 77 and the inclined face 63 is prevented.

The pair of lead wires 6 extending from the electronic component unit 1 after the assembly is completed (see FIG. 1) is electrically connected to electric wires extending from a temperature detection device (not shown). Accordingly, an electric signal (a signal indicating the temperature around the thermistor element) output from the electronic component 10 (thermistor element) is input to the temperature detection device, and the temperature around the thermistor element can be detected.

### <Operations and Effects>

With the electronic component unit 1 according to the present embodiment described above, respective one of the pair of terminals 30 connected to the electronic component 10 embedded in the accommodation body 20 of the base member 2 and exposed from the accommodation body 20 is accommodated in respective one of the pair of accommodation chambers 81 of the housing 3. The pair of accommodation chambers 81 accommodates the pair of terminals 30 in a manner separated from each other. Further, a pair of electric wires (lead wires 6) is connected to the pair of terminals 30 and inserted inside and outside the pair of accommodation chambers 81. Accordingly, one terminal 30 and a contact point between this terminal 30 and the electric wire 6 are appropriately insulated from the other terminal 30 and a contact point between this terminal 30 and the electric wire 6 without using a sealing material as in the electronic component unit in the related art. Further, since the above insulation can be achieved by assembling the housing 3 to the base member 2, productivity of the electronic component unit 1 can be improved as compared with the case where a sealing material is used as in the electronic component unit in the related art. Therefore, the electronic component unit 1 according to the present embodiment has excellent productivity and can appropriately insulate the terminals from each other and the contact points from each other.

Further, with the electronic component unit 1 according to the present embodiment, the electric wires 6 are connected in advance to the terminals 30 exposed from the accommodation body 20 of the base member 2, and then a first housing (case 4) can be assembled to the base member 2 while the terminals 30 and the electric wires 6 pass through the slit portion 55 of the first housing 4. Further, the first housing 4 in this manner is assembled to the base member 2, then a second housing (cover 5) is assembled to the first housing 4, an opening end portion of the first housing 4 can be closed by the second housing 5, and the slit portion 55 of the first housing 4 can be closed by the extending portion 72 of the second housing 5. In addition, when the extending portion 72 is engaged with the base member 2, unintentional separation of the first housing 4 and the second housing 5 from the base member 2 is prevented. Accordingly, the first housing 4 and the second housing 5 can be firmly assembled to the base member 2 without requiring a complicated assembling operation.

Further, with the electronic component unit 1 according to the present embodiment, a first regulation portion (the projection portion 57) of the first housing 4 overlaps the extending portion 72, and the deformation of the extending portion 72 to separate from the slit portion 55 is regulated. Accordingly, the unintentional separation of the first housing 4 and the second housing 5 from the base member 2 is further prevented.

Further, with the electronic component unit 1 according to the present embodiment, a second regulation portion (inclined face 77) of the second housing 5 is engaged with the opening end portion of the first housing 4, and the deformation of the first housing 4 to widen the slit portion 55 is regulated. Accordingly, a state where the slit portion 55 of the first housing 4 is closed by the extending portion 72 of the second housing 5 is maintained. Accordingly, it is possible to firmly maintain a state where the accommodation chamber 81 inside the first housing 4 is separated from the outside.

Further, with the electronic component unit 1 according to the present embodiment, the electric wire 6 is press-fitted into an opening portion (recess portion 62) of the housing 3. Accordingly, even when an external force is applied to the electric wire 6 extending from the electronic component unit 1, the external force is prevented from being applied to the contact point between the electric wire 6 and the terminal 30. Accordingly, reliability of the electrical connection between the electric wire 6 and the terminal 30 can be improved.

Further, with the electronic component unit 1 according to the present embodiment, the electric wire 6 and the terminal 30 are connected to each other by welding. Accordingly, as compared with the case where the electric wire and the terminal are connected to each other by crimping a crimping piece provided on the terminal, even when the electric wire 6 used in the electronic component unit 1 has different sizes, it is not necessary to change specifications such as changing the size of the crimping piece, and thus the electric wire 6 and the terminal 30 can be connected to each other by a common welding operation. Accordingly, the productivity of the electronic component unit 1 can be further improved.

### OTHER EMBODIMENTS

The present invention is not limited to the above embodiment, and various modifications can be adopted within the scope of the present invention. For example, the present invention is not limited to the above embodiment, and modifications, improvements, and the like can be appropriately made. In addition, materials, shapes, sizes, numbers, arrangement positions, and the like of the components in the above embodiment are freely selected and are not limited as long as the present invention can be implemented.

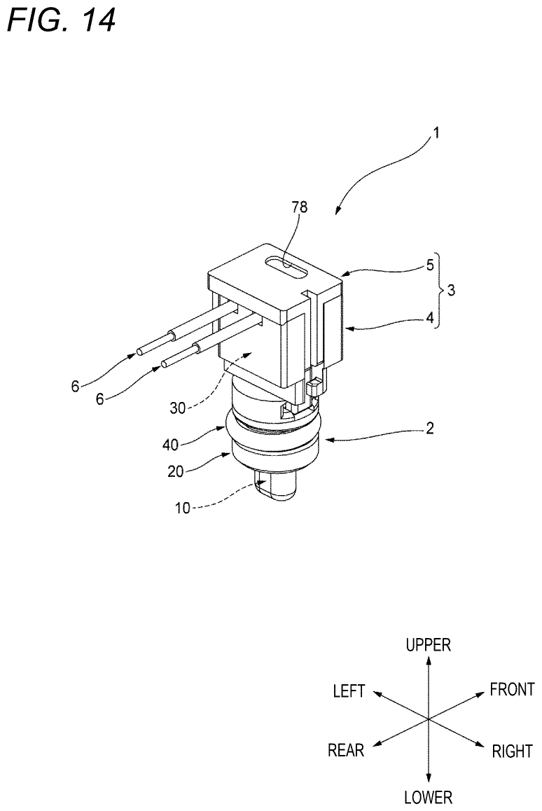

For example, in the above embodiment, the contact point between the terminal 30 extending from the base member 2 and the lead wire 6 and the lead wire 6 extending from the terminal 30 are not embedded in a sealing material such as a potting material inside the case 4 (body portion 51) (see FIG. 13). In contrast, in a modification shown in FIG. 14, a hole (through hole) 78 is formed in the top plate portion 71 of the cover 5. In this modification, the potting material can be poured into the case 4 (body portion 51) through the hole 78 and solidified. Accordingly, in the case 4 (body portion 51), when the contact point between the terminal 30 extending from the base member 2 and the lead wire 6 and the lead wire 6 extending from the terminal 30 are embedded in a sealing material such as a potting material, it is possible to achieve further insulation between the terminals and between the contact points.

Here, features of the embodiment of the electronic component unit 1 according to the present invention described above will be briefly summarized and listed in the following [1] to [7].

[1]

An electronic component unit (1) including:
a base member (2) including an electronic component (10), an accommodation body (20) for accommodating the electronic component (10) by embedding the electronic component (10) therein, and a pair of terminals (30) connected to the electronic component (10) and exposed to an outside of the accommodation body (20);
a housing (3) assembled to the base member (2) and having a pair of accommodation chambers (81) for accommodating the pair of terminals (30) in a manner separated from each other; and
a pair of electric wires (6) connected to respective one of the pair of terminals (30) inside respective one of the pair of accommodation chambers (81) and inserted inside and outside respective one of the pair of accommodation chambers (81) while being held by the housing (3).

With the electronic component unit according to the above [1], respective one of the pair of terminals connected to the electronic component embedded in the accommodation body of the base member and exposed from the accommodation body is accommodated in respective one of the pair of accommodation chambers of the housing. The pair of accommodation chambers accommodates the pair of terminals in a manner separated from each other. Further, the pair of electric wires is connected to the pair of terminals and inserted inside and outside the pair of accommodation chambers while being held by the housing. Accordingly, the electronic component and the terminal are fixed to the accommodation body, the electric wires are held by the housing, and respective one of contact points between the terminals and the electric wires is separately accommodated in respective one of the accommodation chambers without using a sealing material as in the electronic component unit in the related art. Further, since the electronic component unit can be formed by assembling the base member, the housing, and the electric wires as compared with the case of using the sealing material, an injection device or the like for the sealing material is not required in a production facility. Therefore, the electronic component unit having this configuration has an excellent production cost, and can fix each component and insulate the contact points from each other.

[2]

In the electronic component unit (1) according to the above [1], the housing (3) includes a first housing (4) and a second housing (5), the first housing (4) including a cylindrical peripheral wall portion (51) surrounding the pair of terminals (30) extending from the base member (2) and a slit portion (55) formed by cutting out a part of the peripheral wall portion (51) in a cylinder axis direction, one opening end portion (53) of the peripheral wall portion (51) being assembled to the base member (2), the second housing (5) being assembled to the first housing (4) so as to close the other opening end portion of the first housing (4), and the second housing (5) includes an extending portion (72) extending toward the base member (2) to close the slit portion (55) and engaging with the base member (2).

With the electronic component unit according to the above [2], the electric wires are connected in advance to the terminals exposed from the accommodation body of the base member, and then the first housing can be assembled to the base member while the terminals and the electric wires pass through the slit portion of the first housing. Further, the first housing in this manner is assembled to the base member, then the second housing is assembled to the first housing, the opening end portion of the first housing can be closed by the second housing, and the slit portion of the first housing can be closed by the extending portion of the second housing. In addition, when the extending portion is engaged with the base member, unintentional separation of the first housing and the second housing from the base member is prevented. Accordingly, the first housing and the second housing can be firmly assembled to the base member without requiring a complicated assembling operation.

[3]

In the electronic component unit (1) according to the above [2], the first housing (4) includes a first regulation portion (57) that extends from an edge portion of the slit portion (55) so as to overlap the extending portion (72) and that regulates deformation of the extending portion (72) to separate from the slit portion (55).

With the electronic component unit according to the above [3], the first regulation portion of the first housing overlaps the extending portion, and the deformation of the extending portion to separate from the slit portion is regulated. Accordingly, the unintentional separation of the first housing and the second housing from the base member is further prevented.

[4]

In the electronic component unit (1) according to the above [2], the second housing (5) includes a second regulation portion (77) that is engaged with the other opening end portion (63) of the first housing (4) and that regulates deformation of the first housing (4) to widen the slit portion (55).

With the electronic component unit according to the above [4], the second regulation portion of the second housing is engaged with the opening end portion of the first housing, and the deformation of the first housing to widen the slit portion is regulated. Accordingly, a state where the slit portion of the first housing is closed by the extending portion of the second housing is maintained. Accordingly, it is possible to firmly maintain a state where the accommodation chamber inside the first housing is separated from the outside.

[5]

In the electronic component unit (1) according to the above [2], the second housing (5) includes a separation wall (74) that separates the pair of accommodation chambers (81), and the separation wall (74) is in pressure contact with the base member (2).

With the electronic component unit according to the above [5], the separation wall of the second housing is in pressure contact with the base member, whereby the pair of accommodation chambers can be more reliably separated from each other.

[6]

The electronic component unit (1) according to the above [1], the housing (3) has an opening portion (62) through which respective one of the pair of electric wires (6) is inserted inside and outside respective one of the pair of accommodation chambers (81) while being press-fitted and held.

With the electronic component unit according to the above [6], the electric wire is press-fitted into the opening portion of the housing. Accordingly, even when an external force is applied to the electric wire extending from the electronic component unit, the external force is prevented from being applied to the contact point between the electric wire and the terminal. Accordingly, reliability of the electrical connection between the electric wire and the terminal can be improved.

[7]

The electronic component unit (1) according to the above [1], respective one of the pair of electric wires (6) is welded to respective one of the pair of terminals (30).

With the electronic component unit according to the above [7], the electric wire and the terminal are connected to each other by welding. Accordingly, as compared with the case where the electric wire and the terminal are connected to each other by crimping a crimping piece provided on the terminal, even when the electric wire used in the electronic component unit has different sizes, it is not necessary to change specifications such as changing the size of the crimping piece, and thus the electric wire and the terminal can be connected to each other by a common welding operation. Accordingly, the production cost of the electronic component unit can be further reduced.

1. An electronic component unit comprising:
a base member including an electronic component, an accommodation body for accommodating the electronic component by embedding the electronic component therein, and a pair of terminals connected to the electronic component and exposed to an outside of the accommodation body;
a housing assembled to the base member and having a pair of accommodation chambers for accommodating the pair of terminals in a manner separated from each other; and
a pair of electric wires connected to respective one of the pair of terminals inside respective one of the pair of accommodation chambers and inserted inside and outside respective one of the pair of accommodation chambers while being held by the housing.

2. The electronic component unit according to claim 1, wherein
the housing includes
a first housing including a cylindrical peripheral wall portion surrounding the pair of terminals extending from the base member and a slit portion formed by cutting out a part of the peripheral wall portion in a cylinder axis direction, one opening end portion of the peripheral wall portion being assembled to the base member, and
a second housing assembled to the first housing so as to close the other opening end portion of the first housing, and
the second housing includes an extending portion extending toward the base member to close the slit portion and engaging with the base member.

3. The electronic component unit according to claim 2, wherein
the first housing includes a first regulation portion that extends from an edge portion of the slit portion so as to overlap the extending portion and that regulates deformation of the extending portion to separate from the slit portion.

4. The electronic component unit according to claim 2, wherein
the second housing includes a second regulation portion that is engaged with the other opening end portion of the first housing and that regulates deformation of the first housing to widen the slit portion.

5. The electronic component unit according to claim 2, wherein
the second housing includes a separation wall that separates the pair of accommodation chambers, and
the separation wall is in pressure contact with the base member.

6. The electronic component unit according to claim 1, wherein
the housing has an opening portion through which respective one of the pair of electric wires is inserted inside and outside respective one of the pair of accommodation chambers while being press-fitted and held.

7. The electronic component unit according to claim 1, wherein
each one of the pair of electric wires is welded to each one of the pair of terminals.
